(19) United States
(12) Patent Application Publication
(10) Pub. No.: US 2012/0279366 A1
(43) Pub. Date: Nov. 8, 2012

(54) PIPE CUTTER AND METHOD

(75) Inventor: Michael Tjader, New Richmond, WI (US)

(73) Assignee: TT Technologies, Inc., Aurora, IL (US)

(21) Appl. No.: 13/463,397

(22) Filed: May 3, 2012

Related U.S. Application Data
(60) Provisional application No. 61/482,135, filed on May 3, 2011.

(51) Int. Cl. B23D 21/08; B23B 1/00

(52) U.S. Cl. 82/1.11; 30/101; 30/96

(57) ABSTRACT

A pipe cutter and methods are shown. Examples of pipe cutters allow a user to only rotate the pipe cutter back and forth by a small number of degrees sufficient to provide each path cut by a number of cutter wheels to intersect. Cutter wheels with shoulders are shown, that keep cutting blades from penetrating to an inner diameter of a protective housing.

### PRIORITY APPLICATIONS

This patent application claims the benefit of priority, under 35 U.S.C. Section 119(e), to U.S. Provisional Patent Application Ser. No. 61/482,135, filed on May 3, 2011, which is incorporated herein by reference.

### BACKGROUND

Trenchless pipe replacement is useful for replacement of pipes without the need to excavate the length of the pipe to be replaced. An example of trenchless pipe replacement includes pulling a cutting blade with an expander through the pipe to be replaced, and attaching a new pipe behind the cutting blade. The pipe to be replaced is split, and pushed into the surrounding soil, and the new pipe, of equal or larger diameter, is pulled into the new space within the split pipe. Splitter are commonly used for small diameter pipes, and for pipes of a material that lends itself to splitting. Another example of trenchless pipe replacement includes pipe bursting.

Gas lines are one example of pipes where splitting is useful in pipe replacement. An example includes high density polyethylene (HDPE) gas pipe. Large quantities of 2 inch diameter HDPE gas pipes are currently in need of replacement. 300 miles of gas pipe in a single city in need of replacement is not uncommon. Given the desirability of minimizing trenches, it is also desirable to minimize the size of entry and exit pits for operating trenchless equipment. Cutting pipes in small entry and exit pits can be a challenge due to the small amount of available space to operate cutting tooling.

### BRIEF DESCRIPTION OF THE DRAWINGS

FIG. 1 shows an isometric view of a pipe cutter according to an embodiment of the invention.

FIG. 2 shows a cross section view of a pipe cutter according to an embodiment of the invention.

FIG. 3 shows another cross section view of a pipe cutter according to an embodiment of the invention.

FIG. 4 shows an example pipe splitting operation for use with a pipe cutter according to an embodiment of the invention.

FIG. 5 shows a flow chart of an example method according to an embodiment of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and mechanical, structural, or logical changes, etc. may be made without departing from the scope of the present invention.

FIG. 1 shows an example of a pipe cutter 100 according to an embodiment of the invention. The pipe cutter 100 includes a body 110. The body 110, further includes a fixed body portion 112, and an adjustable body portion 114. An example length of pipe 102 is shown within the pipe cutter 100 in a position ready to be cut. In the example shown, both the fixed body portion 112, and an adjustable body portion 114 include arced shaped inner portions that include cutter wheels 116. The arc shaped portions are shaped to fit closely around the pipe 102.

Examples of pipe 102, include plastic pipe, and metal pipes of several different compositions. For example the pipe cutter 100 is useful to cut high density polyethylene (HDPE) pipe, poly vinyl chloride (PVC) pipe, poly ethylene terepthalate (PET) pipe, etc., as well as steel pipe, copper pipe, cast iron pipe, and other metal pipes.

A handle 118 is shown to actuate movement of the adjustable body portion 114. Although a handle 118, that turns a threaded rod is shown as an example, other actuation devices are contemplated within the scope of the invention. Other examples may include mechanical devices such as camming devices, linkages, ratchets, etc. Electrically actuated devices, or hydraulically actuated devices are also within the scope of the invention.

To facilitate getting the pipe cutter 100 around a length of pipe 102, the pipe cutter 100 can be opened, or otherwise partially disassembled by opening or removing the fixed body portion 112 from the body 110. A first attachment point 113A and a second attachment point 113B are shown to provide the opening or removing function. In one example, a fixed pivot pin is used at one of the attachment points 113A, 113B, and a removable pin is used at the other attachment point 113A, 113B. Other configurations may include two removable pins at the attachment points 113A, 113B, or other variations of fasteners, such as bolts, screws, etc. In one example, fixed pivot pin is used at one of the attachment points 113A, 113B, and spring loaded latch is used at the other attachment point 113A, 113B. Another example may include two spring loaded latches at the attachment points 113A, 113B.

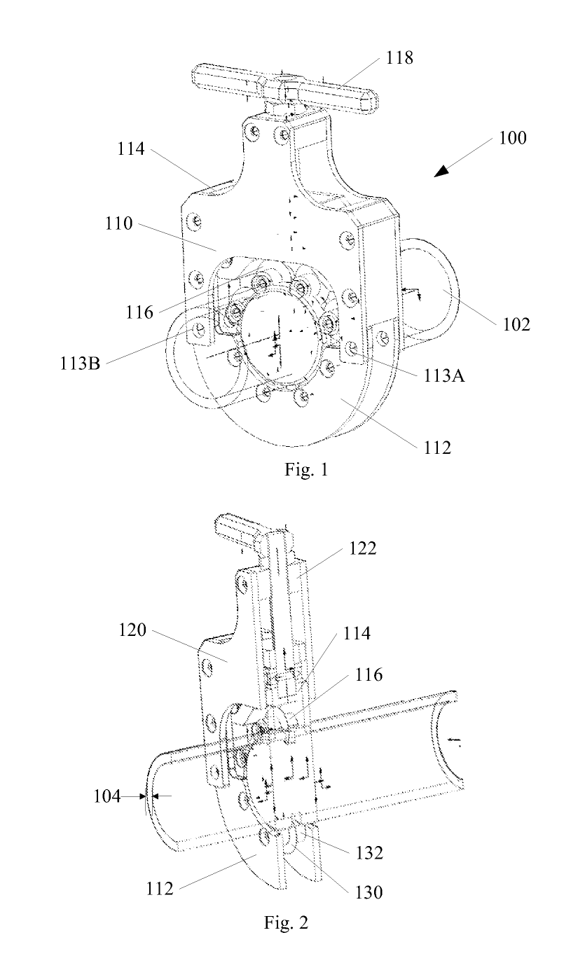

FIG. 2 shows a cross section of the pipe cutter 100 engaging the pipe 102. The body 110 is shown in this example as a pair of plates spaced apart by one or more spacer blocks 122. The spacer block 122 shown in FIG. 2 further includes a threaded hole to facilitate controlled movement of the adjustable body portion 114.

A number of cutter wheels 116 are shown in the pipe cutter 100. The number of cutter wheels are substantially equally spaced apart by a number of degrees around a circumference formed by the arced portions of the fixed body portion 112, and an adjustable body portion 114. As a result, each of the substantially equally spaced apart cutter wheels is in contact, or close proximity to a circumference line of cut on the pipe 102.

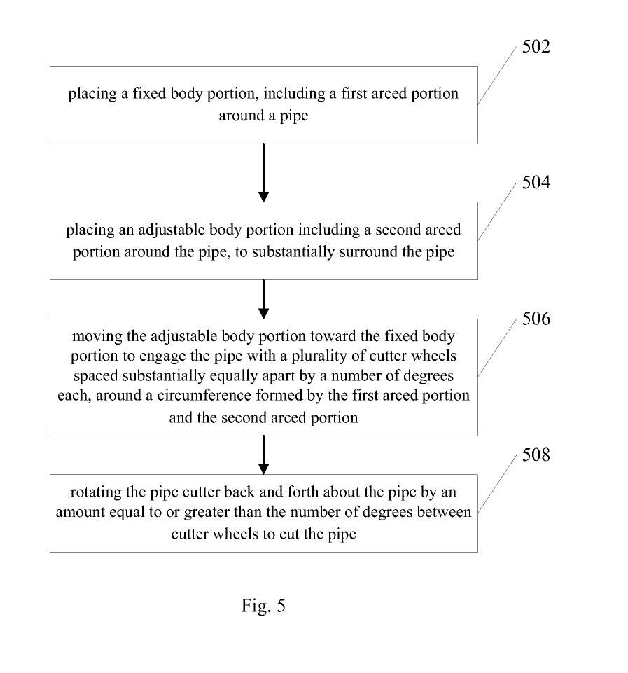

In one example the number of cutter wheels 116 includes as many cutter wheels as possible to fit around the circumference without overlapping of cutter wheels, for a given circumference and cutter wheel diameter. FIG. 1 shows eight cutter wheels spaced substantially equally apart around the circumference formed by the arced portions of the fixed body portion 112, and an adjustable body portion 114. For the given size of the cutter wheels 116 in the Figure, no additional cutter wheels 116 would fit around the circumference. If a diameter of the cutter wheels 116 were smaller, for the same diameter of pipe 102 shown, more cutter wheels 116 may fit up to some number, where no additional cutter wheels 116 would fit without overlapping. This configuration of many cutter wheels spaced very close together has a number of advantages, as are discussed in more detail below regarding FIG. 5.

At least one cutter wheel 116 includes a blade 130 and a shoulder portion 132. In one example, more than one cutter wheel 116 includes a blade 130 and a shoulder portion 132. In one example, all cutter wheels 116 includes a blade 130 and a shoulder portion 132. The cutter wheels are designed to cut a pipe 102 with a wall thickness 104 that is matched to the cutter wheels 116.

In one example, the blade 130 includes a height exposed above the shoulder 132 that is slightly less than the wall thickness 104 of the pipe 102. This configuration ensures that when cutting, the blade 130 will not penetrate into the inside of the pipe 102, because the shoulder 132 will contact an outer diameter of the pipe 102 before the blade 130 can penetrate further than the wall thickness 104.

In one example, the blade 130 further includes a wedge shape, above the shoulder 132. A wedge shape of the blade 130 is useful to urge a split to open, and to separate the cut portions of pipe apart along the pipe axis, as the blade is advanced further into the pipe 102.

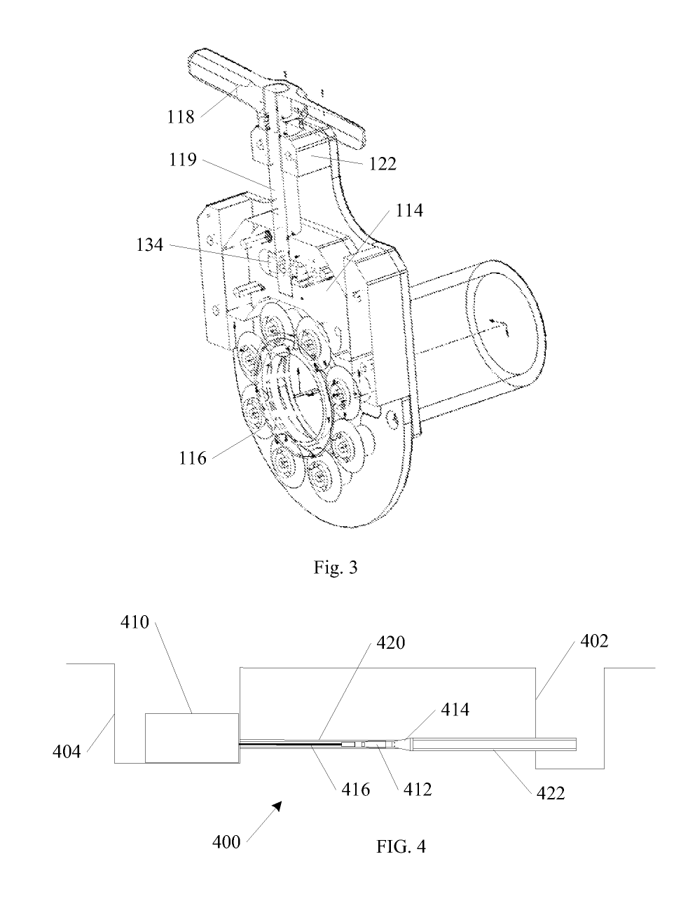

FIG. 3 shows the pipe cutter 100 with a different cross sectional view from FIG. 2. The cross section in FIG. 3 shows the handle 118 coupled to a threaded shaft 119. The threaded shaft 119 is in turn coupled to the adjustable body portion 114 using a bearing 134. It can be seen from the Figure, that turning of the handle 118 will advance the adjustable body portion 114 towards the fixed body portion 112, held in place against the body 110 by the attachment points 113A, 113B. In one example bearings, such as the bearing 134, or bearings in the cutter wheels 116, include oiled bronze bearings. In other examples one or more bearings may include cartridge bearings, polymer sleeve bearings or other types of bearings.

FIG. 4 shows a splitter system 400 in operation performing a split and replacement. During several operations of new pipe installation, cutting the pipe to a desired length, or trimming a length of the new pipe is required. Embodiments of the pipe cutter 100 can be very useful for cutting pipes 422. Particularly when the pipes 422 are in close quarters, within an entry pit 402 or an exit pit 404.

FIG. 4 shows an entry pit 402 and an exit pit 404, with a pipe 420 that is to be replaced by the splitting operation. A pulling system is shown with a puller 410 illustrated in block diagram form. A pulling member 416 is shown coupled to the puller 410 and to a splitter 412. In operation, the puller 410 engages and advances the pulling member 416 to move the splitter 412 from the entry pit 402 to the exit pit 404. An expander 414 is also shown coupled to the splitter 412. The expander expands the pipe 420 after the splitter 412 weakens or splits the pipe 420 as will be described in more detail below. A new pipe 422 is also shown coupled to the expander. In one embodiment, the new pipe 422 is pulled into the cavity formed by the expander as the splitter 412 and expander 414 combination is pulled.

A number of puller 410 and pulling member 416 options are possible. In one example, the pulling member included a number of pulling rods that are joined together in sections, and the puller includes a rod puller. One example of a rod puller engages the rods in a number of notches or openings in the rods (not shown). In one embodiment, the rods are first pushed through the pipe to be replaced, then the splitter system is coupled to the rods and the splitter system is drawn back through the pipe, as described above. In one embodiment, a leading portion with a swivel joint such as a ball joint is attached to a front end of the rods prior to pushing the rods through the pipe to be replaced. A short leading portion, such as an approximately six inch long portion with an rounded nose, provides improved tracking of the rods within the pipe to be replaced. Improved tracking helps prevent the rods from accidentally pushing through a wall of the pipe to be replaced.

Other examples of a puller 410 and pulling member 416 includes a cable, wire rope, etc. pulling member 416 that is pulled by a winch, cyclic cable puller, or other cable puling device. Other pullers 410 and pulling members 416 are also possible, such as directional drill stem sections, etc.

In addition to pulling options, in one embodiment, a number of rods are used to push an embodiment of a splitter system. In one example, after the splitter system is pushed through the pipe to be replaced, at least portions of the splitter system are removed, and the new pipe is attached to an expander and pulled back by the same rod puller/pusher.

New pipe installed in example operations described above can be difficult to cut, given confined dimensions of the entry pit 402 or exit pit 404. Examples of pipe cutters and methods described above can make the pipe cutting process much easier.

FIG. 5 shows a method of operating a pipe cutter according to an embodiment of the invention. In operation 502, a fixed body portion, including a first arced portion is placed around a pipe. An example of a fixed body portion, includes fixed body portion 112 as discussed in embodiments above. Operation 504 recites placing an adjustable body portion including a second arced portion around the pipe, to substantially surround the pipe. An example of an adjustable body portion, includes adjustable body portion 114 as discussed in embodiments above.

Operation 506 recites moving the adjustable body portion toward the fixed body portion to engage the pipe with a plurality of cutter wheels. In one example, a handle, such as handle 118 is used to engage cutter wheels, such as cutter wheels 116, spaced substantially equally apart by a number of degrees each, around a circumference formed by the first arced portion and the second arced portion.

Operation 508 recites rotating the pipe cutter back and forth about the pipe by an amount equal to or greater than the number of degrees between cutter wheels to cut the pipe. Configurations that include a number of cutter wheels, spaced substantially equally apart are uniquely able to cut a pipe without rotating the pipe cutter 360 degrees around the pipe to be cut. The greater the number of cutter wheels spaced substantially equally apart, the smaller the number of degrees separating the cutting surfaces of each cutter wheel.

Because of limited room within an exit or entry pit, it may be difficult or impossible to rotate a pipe cutter all the way around, or even half way around a pipe to be cut. Embodiments shown above, allow a user to only rotate the pipe cutter back and forth by a small number of degrees sufficient to provide each path cut by the cutter wheels 116 to intersect. One particular example of small exit or entry pits includes “keyhole” operations, where exit and entry pits are typically to small for a person to fit down into.

Pipe cutters shown above may be used with any of a number of plastic or metal pipe materials, in a number of different trenchless pipe replacement operations. One example includes a natural gas line pipe replacement. Some gas line replacements require a protective outer sleeve with the replacement gas line located within the outer protective sleeve. Great care in cutting is required in any configuration where sensitive product such as gas, electrical or fiber optic cable is housed within a protective housing. Embodiments of the present invention are efficient at cutting in tight spaces, therefore reducing brute force accidents where cutting is difficult. Further, features such as cutter wheels with shoulders that keep cutting blades from penetrating to an inner diameter of a protective housing provide an additional level of safety, and extra protection of whatever sensitive product may be housed within a pipe or housing.

While a number of advantages of embodiments of the invention are described, any lists of above mentioned advantages are not intended to be exhaustive. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and methods are used. The scope of the invention should be determined with reference to the appended claims, along with the full scope of equivalents to which such claims are entitled.

We claim:

1. A pipe cutter, comprising:
a fixed body portion, including a first arced portion shaped to fit around a pipe;
an adjustable body portion including a second arced portion shaped to fit around the pipe, the adjustable body portion, movable in relation toward the fixed body portion to bring the first arced portion and the second arced portion towards each other; and
a plurality of cutter wheels spaced substantially equally apart by a number of degrees each, around a circumference formed by the first arced portion and the second arced portion.

2. The pipe cutter of claim 1, wherein one or more of the plurality of cutter wheels includes a shoulder, leaving a blade height exposed over the shoulder, wherein the blade height is less than a pipe wall thickness to be cut.

3. The pipe cutter of claim 1, further including a threaded adjuster to move the adjustable body portion towards the fixed body portion.

4. The pipe cutter of claim 1, wherein the plurality of cutter wheels includes as many cutter wheels as possible to fit around the circumference without overlapping of cutter wheels, for a given circumference and cutter wheel diameter.

5. A method of operating a pipe cutter, comprising:
placing a fixed body portion, including a first arced portion around a pipe;
placing an adjustable body portion including a second arced portion around the pipe, to substantially surround the pipe;
moving the adjustable body portion toward the fixed body portion to engage the pipe with a plurality of cutter wheels spaced substantially equally apart by a number of degrees each, around a circumference formed by the first arced portion and the second arced portion; and
rotating the pipe cutter back and forth about the pipe by an amount equal to or greater than the number of degrees between cutter wheels to cut the pipe.

6. The method of claim 5, wherein the pipe is a plastic pipe.

7. The method of claim 6, wherein the pipe is a protective sheath that surrounds a second pipe enclosed within the protective sheath.

8. The method of claim 7, wherein the second pipe is a natural gas supply pipe.
